(19) United States
(12) Patent Application Publication
(10) Pub. No.: US 2016/0111938 A1
(43) Pub. Date: Apr. 21, 2016

(54) KINETIC ENERGY COLLECTOR MECHANISM TO GENERATE ELECTRIC POWER FROM PASSING VEHICLES, USING A MAIN AXLE CONNECTED TO A FLYWHEEL

(71) Applicant: Hugo Roberto Diaz, Resistencia-Chaco (AR)

(72) Inventor: Hugo Roberto DIAZ, Resistencia-Chaco (AR)

(21) Appl. No.: 14/887,610

(22) Filed: Oct. 20, 2015

(30) Foreign Application Priority Data
Oct. 20, 2014 (AR) 20140103925

(51) Int. Cl. H02K 7/18; H02K 7/02; E01B 26/00; F03G 3/08; F03G 7/08

(52) U.S. Cl. CPC H02K 7/1853; F03G 3/08; F03G 7/08; E01B 26/00; H02K 7/025

(57) ABSTRACT

A kinetic energy collector mechanism for generating electric power from passing vehicles, using a main axle connected to a flywheel, wherein the main axle is supported on two bearings and/or rollers, said main axle having a half-cylindrical support section for the vehicle wheels, and having attached on each end at least one flywheel that is mounted so as to transmit load in only one direction while it can rotate freely in the opposite direction, said main axle rotating in an angle ranging between 0° and 120°, preferably 45°, equivalent to 1/8th of a turn as the vehicle wheels pass over the half-cylindrical section of the main axle, thus driving the attached flywheel; wherein the main axle is returned to its original resting position by means of springs, then reapeating the rotational motion every time the main axle is driven by passing vehicle wheels; and wherein, the flywheel has enough driving force to rotate and drive a generator and its corresponding regulator by mechanical means that transmit the load to said generator with its corresponding regulator, which in turn generates electric power that is either delivered to a power network or charged in batteries.

### FIELD OF THE INVENTION

The present invention refers to the field of electric power generators, particularly to those generators that do not pollute the environment and also use alternative sources of energy.

### BACKGROUND OF THE INVENTION

Power consumption has increased rapidly during recent years. In the United States and in other developed countries, for example, the increased number of hybrid/electrical vehicles has increased the need to build more power plants.

The present invention is considered to be included in the general category of renewable power sources, such as, but not limited to, windpower systems, hydroelectric power systems, solar power systems, and gravitational power systems, in all of which the source of energy is basically free of cost.

In the context of mechanically-driven power systems, the mass and the kinetic energy/impulse from the motion of vehicles on a road, for example cars and trucks, or on a railway, for example, trains or underground trains, are a free source of energy that can be used and also potentially stored for further consumption.

### SUMMARY OF THE INVENTION

It is then the object of the present invention, to provide a kinetic energy collector mechanism for generating electric power from passing vehicles, comprising a main axle connected to a wheel, wherein the main axle is supported on two bearings and/or rollers, said main axle having a half cylindrical cross section supporting vehicle wheels, on which axle ends at least one wheel is mounted thereon which is able to transmit load in only one direction, while it can rotate freely in the opposite direction, said main axle being able to rotate by an angle ranging between 0° and 120°, preferably 45°, which is equivalent to ⅛th of a complete turn of the axle as the vehicle wheels step on the flat side of the half cylindrical section of the main axle, thus driving forward the wheel mounted on the axle end; wherein, the main axle is returned to its original resting position under the action of springs, then reapeating the rotational motion every time than the main axle is actuated by passing vehicle wheels; and wherein, the axle wheel has sufficient power to rotate and drive a generator with its corresponding regulator by mechanical means, thus transmitting the load to said generator with its corresponding regulator, which in turn generates electric power that will be either fed into a network or charged on batteries.

Preferably, the wheel is a flywheel or a freewheel.

Also preferably, the main axle is connected to a wheel at one of its ends.

Most preferably, the generator is a dynamo, an alternator, or a combination thereof.

More preferably, the mechanical means transmitting the load are belt and pulley systems, gears, or a combination thereof.

In a more preferred embodiment, the kinetic energy collector mechanism is mounted on a street or road with the main axle located between two platforms with an upward or downward inclination and fixed to the ground surface.

In another preferred embodiment, the kinetic energy collector mechanism it is mounted on a railway section.

### BRIEF DESCRIPTION OF THE FIGURES

FIG. 1 is a diagram of a preferred embodiment of the mechanism according to the present invention, where three stages (A, B y C) are shown from right to left as a vehicle wheel (shown at the front) runs over the mechanism and drives an axle with a half-cylindrical cross section, which in turn drives a flywheel (shown behind it). At A, the vehicle wheel contacts the half-cylindrical axle at the top of an upward inclined platform. At B, the axle has started to rotate, thus driving the flywheel as the vehicle wheels pass from the upward platform to a downward platform. At C, the vehicle wheels start running along the downward platform, while the flywheel continues rotating.

FIG. 2 is a schematic view of a further preferred embodiment of the mechanism according to the present invention, which is mounted on a railway section, wherein a train wheel passing above the half-cylindrical axle causes it to drive a flywheel. It should be noted that no upward or downward sections are used here.

FIG. 3 shows an additional embodiment of the mechanism of the present invention, wherein a vehicle is located at position B in FIG. 1, as seen from the front (I) and from the back (II). The mechanism illustrated herein comprises two flywheels respectively mounted on both ends of the half-cylindrical axle. FIG. 4 is a schematic view of the A-B section of FIG. 3 (1) shown on each of the stages (A, B y C) of FIG. 1 from right to left, as the vehicle wheels passes on and drives the half-cylindrical axle. Position A shows the mechanism in its resting position, that is, subject to no load; position B shows the mechanism in active position, that is, under load, while position C shows the mechanism once again in its resting position, without load, after the vehicle wheels have passed and both the half-cylindrical axle and the attached flywheel are set in motion. FIG. 5 is a plan view of the mechanism according to the present invention, shown schematically at stage B in FIG. 1. The main parts of said mechanism are shown, namely: (1) support section, (2) bearing or anti-friction bands, (3) main axle (4) flywheel (freewheel) transmitting load in only one direction, while it can rotate freely in the opposite direction, (5) upward and downward platforms, (6) vehicle wheel, (7) springs, (8) pulley, (9) belt, (10) generator (alternator o dynamo), (11) road surface, (12) gearwheel, y (13) fixing supports.

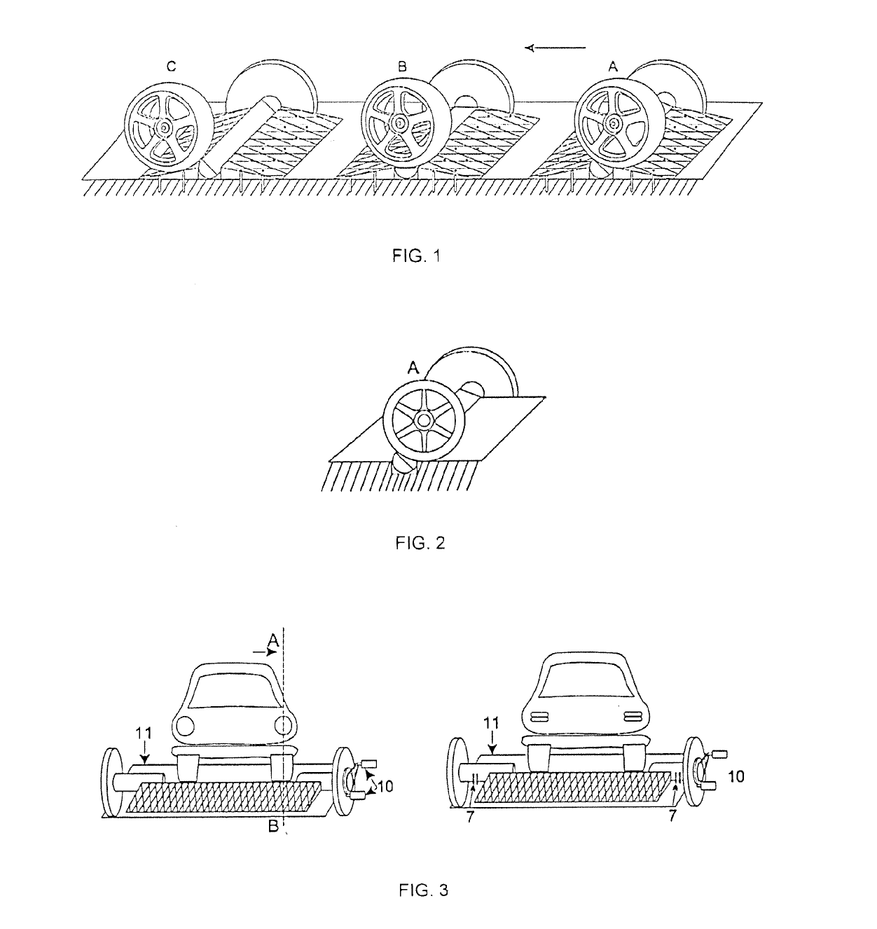

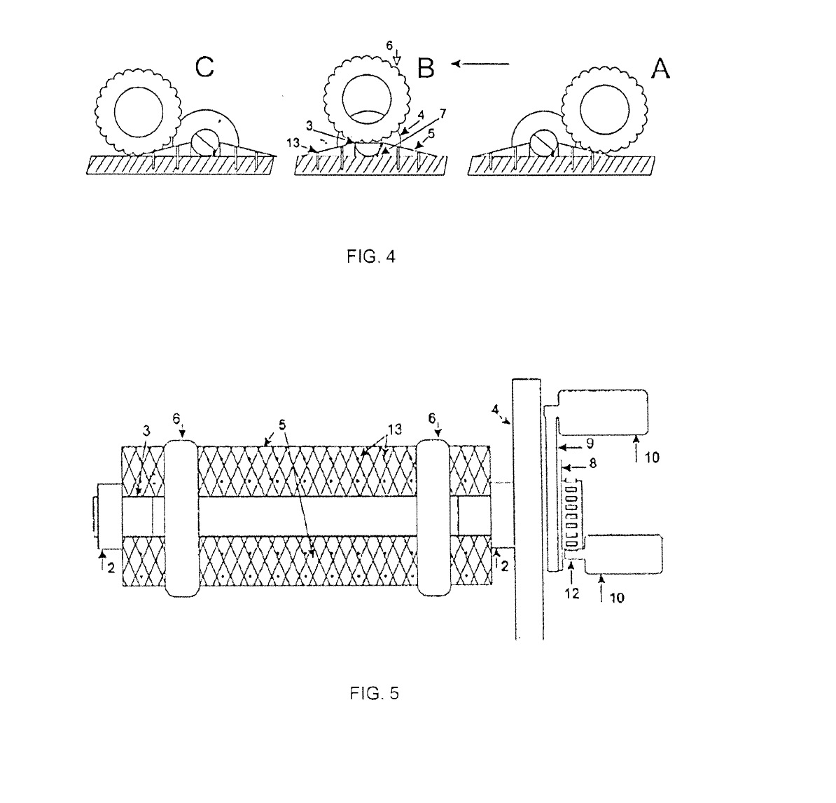

### DETAILED DESCRIPTION OF THE INVENTION

The present invention refers to a system intended to collect kinetic energy from passing vehicles and transmitting it to a flywheel by means of a half-cylindrical axle, then converting the mechanical energy in the flywheel to electric power by means of an alternator or a dynamo, and delivering it to a power network or to batteries.

This invention related to the generation of power from moving vehicles differs from any other system because it comprises a half-cylindrical axle which is driven by vehicles passing thereabove, thus collecting the kinetic energy from passing vehicles in the axle flywheel.

These features allow for almost no maintenance needs, a very simple and non-invasive installation, since the system comprises few components, and besides the road on railway need not be modified to install it.

Therefore, the present invention is directed to a kinetic energy collector mechanism for generating electric power from passing vehicles, using a main axle (3) connected to a flyweel (4), wherein the main axle (3) is supported on two bearings (2) and/or rollers mounted across the path of a vehicle, wherein said main axle has a half-cylindrical cross section at the support section (1) of the main axle (3).for the vehicle wheel (6).

When the wheel of the vehicle runs over the main axle (3) it causes it to rotate by ⅛th of a turn, driving the flywheel or freewheel (4) that is attached to one or both ends of the main axle, transmitting the load in only one direction, (while it can rotate freely in the opposite direction), with enough driving force to make the flywheel rotate freely and drive generator, dynamo and/or alternator, with its corresponding regulator (10) by mechanical means, such as pulleys and belts (8, 9) and/or gears (12), thus transmitting the load to the dynamo and/or alternator and its corresponding regulator (10), which in turn produce electric power to be delivered to a power network or to charge batteries.

The main axle (3) is then returned to its original resting position by means of springs (7), and reapeating the rotational movement each time the main axle is actuated by a passing wheel.

In the case of a road for motor vehicles, the mechanism is supported between two platforms (5) with upward or downward inclination respectively, and is mounted by means of a simple attachment system to the road surface (13).

In the case of a railway, the mechanism does not have an upward and downward inclination, i.e. has no platforms, but the mechanism is also attached to the ground surface (13).

1. A kinetic energy collector mechanism for generating electric power from passing vehicles, comprising a main axle (3) connected to a flywheel (4) characterized in that the main axle (3) is supported on two bearings and/or rollers (2), said main axle having a half-cylindrical support section (1) for the vehicle wheels (6), and having at least one flywheel attached to each end (4) of the axle, which are mounted so as to transmit load in only one direction and to rotate freely in the opposite direction, said main axle rotating in an angle ranging between 0° and 120°, preferably 45°, equivalent to ⅛th of a turn as the vehicle wheels pass over the half-cylindrical section of the main axle (3) thus driving the attached flywheel (4).
wherein, the main axle (3) is returned to its original resting position by means of springs (7), then reapeating the rotational motion every time the main axle is driven by passing vehicle wheels, and
wherein, the flywheel has enough driving force to turn and drive a generator with its corresponding regulator (10) by mechanical means transmitting the load to said generator and its corresponding regulator (10), which in turn generates electric power that is either delivered to a power network or charged in batteries.

2. The kinetic energy collector mechanism of claim 1, characterized in that the wheel (4) is a flywheel or a freewheel.

3. The kinetic energy collector mechanism of claim 1, characterized in that the main axle (3) is connected to a flywheel (4) at one of its ends.

4. The kinetic energy collector mechanism of claim 1, characterized in that the generator is a dynamo, an alternator, or a combination thereof.

5. The kinetic energy collector mechanism of claim 1, characterized in that the mechanical means transmitting the load are belt and pulley systems (8, 9), gears (12), or a combination thereof.

6. The kinetic energy collector mechanism of claim 1, characterized in that it is mounted on a street or road with the main axle (3) located between two platforms (5) with an upward or downward inclination respectively, and fixed to the road surface (13).

7. The kinetic energy collector mechanism of claim 1, characterized in that it is mounted on a railway section.
